(19) United States
(12) Patent Application Publication
(10) Pub. No.: US 2002/0087583 A1
(43) Pub. Date: Jul. 4, 2002

(54) On line product distribution and purchasing system

(75) Inventors: Kenneth Edward Morgan, Danville, CA (US); Michelle Constance Lerandean, Oakland, CA (US); Douglas Michael Schnelzer, Ashburn, VA (US); Ilene Feins Landon, Vienna, VA (US)

Correspondence Address: HOWREY SIMON ARNOLD & WHITE LLP, 750 Bering Drive, Houston, TX, 77057-2198, US

(73) Assignee: McKesson Corporation

(21) Appl. No.: 09/753,101

(22) Filed: Jan. 2, 2001

(51) Int. Cl. G06F 17/30

(52) U.S. Cl. 707/200

(57) ABSTRACT

An internet-based system that facilitates the interaction between a store, its distributor, and consumers is disclosed. The system is centered around a distributor website that is designed to interact with both the stores it supplies and with the consumers who shop in those stores. Stores interact with the distributor's website by first using the site to create their own personalized website using a website “wizard.” This wizard program allows stores autonomy in creating their websites and choosing which of the distributor's products they wish to sell on line, but also makes it feasible for the distributor to update all of the created websites with pertinent information such as product pricing. The stores may also use the disclosed system to purchase products from the distributor to stock their stores. Consumers may interact with the distributor's website by utilizing a store locator to locate a store in their vicinity. Thereafter, the consumers may order products on-line from the websites of their local stores. Stores may periodically check the status of on-line orders by logging into the system.

### FIELD OF THE INVENTION

This invention relates generally to an on-line product distribution and purchasing system.

### BACKGROUND OF THE INVENTION

The internet is clearly in the process of revolutionizing the way products are purchased. “Dot com” companies offer products on-line, allowing consumers to purchase products from their computer terminals without leaving their homes or offices. In the new on-line environment, the notion of a consumer's local store begins to fade away, as the store down a consumer's street is replaced by a website.

However, some consumers are uncomfortable buying some types of products on line. For example, purchasers of pharmaceuticals generally are more comfortable buying products from their local pharmacist with whom they can communicate and have established a trusting relationship. These consumers are generally leery of buying such products from a “faceless” website, which generally lacks any human interaction and whose actual physical existence probably remains a mystery to the consumer.

Of course, these local stores could, and often do, post websites of their own to serve their local clientele. Typically such websites are made to mimic the operation of the local store by posting the products for sale and their prices, along with other information such as mechanisms for delivering the purchased products. While such an approach can be sufficient for an independent store, this approach does not work well for local stores that receive their products from a regional or national distribution chain. Take, for example, Valu-Rite® drug stores. Such stores appear all over North America, and receive most of their products, including pharmaceuticals, health and beauty aids, electronics, etc., through a single distributor with whom the store has contracted, perhaps by a franchise agreement. While the individual stores generally pick the products and quantities that they purchase from the distributor, the distributor, for practical reasons, generally suggests the price at which the products will be retailed in a given region. This is true because the price at which the distributor purchases product from a manufacturer is subject to fluctuations.

Accordingly, the distributor and the store generally agree that the store will purchase product from the distributor at a set mark up, which is generally a set percentage of the distributors purchase price, e.g., 5%, but which can also be a fixed value. For example, if the distributor purchases a given product for $10.00, this product will be sold by the store to consumers at $10.50. If in the next month the distributor purchases the same product for $11.00, the product will be sold by the store for $11.55.

However, this distribution/pricing scheme can make it difficult for a given store to operate an on-line website to sell products to its local consumers. Because the store will generally sell products in its physical store at prices according to its agreement with the distributor, the store must generally also sell product on its website at the same price for the practical reason that consumers will not tolerate a price discrepancy between the physical store and the on-line store. This makes matters difficult for the store, who must manually update prices on its website to match those appearing in its store.

A different approach to address this problem would be to have the distributor control the content of the local stores'websites, such as retail pricing and product mix, by having the distributor's database interface with store's websites. However, this approach has other problems. For one, it may be difficult for the distributor to keep track of all of the websites that are being put on line by the stores it supplies. Moreover, having the distributor update the pricing information of all stores prevents any given store from, e.g., having a sale, which it generally has a right to do under its agreement with the distributor. Furthermore, it may difficult for the distributor to know anything regarding the quantity or availability of a particular product at any given local store. For example, a store in Miami, Fla. may not sell any wool gloves, and so having the distributor update the price of wool gloves on that store's website would be pointless and confusing.

What is needed therefore is a way of integrating the websites of local stores in a distribution channel with their distributor in such a way that the stores'website retains a local “flavor” appealing to local clientele, but which are also automatically updated with pertinent information from the distributor and can be tailored by any individual store to meet its specific needs.

### SUMMARY OF THE INVENTION

The disclosed internet-based system facilitates the interaction between a store, its distributor, and consumers. The system is centered around a distributor website that is designed to interact with both the stores it supplies and with the consumers who shop in those stores. Stores interact with the distributor's website by first using the site to create their own personalized website using a website “wizard.” This wizard template allows stores autonomy in creating their websites and choosing which of the distributor's products they wish to sell on line, but also makes it feasible for the distributor to update all of the created websites with pertinent information such as product retail pricing. The stores may also use the disclosed system to purchase products from the distributor to stock their stores. Consumers may interact with the distributor's website by utilizing a store locator to locate a store in their vicinity. Thereafter, consumers may order products on-line from the websites of their local stores. Stores and consumers may periodically check the status of on-line orders by logging into the system.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIG. 1 shows a system integrating a store terminal, a consumer terminal, and a distributor terminal around a distributor's URL.

FIG. 2 shows a screen shot of the home page for the URL.

FIG. 3 shows a screen shot of the page presented to a pharmacist after login into the system.

FIG. 4 shows a flow chart detailing the steps involved in filing out the website wizard provided by the URL.

FIG. 5 shows a screen shot of the portion of the wizard program at which the pharmacist picks which products or product families he or she would like to offer for on-line sale on the website to be created.

FIG. 6 shows an example of a website created using the wizard.

FIG. 7 shows the main components of the distributor terminal of FIG. 1.

FIG. 8 shows a summary of the orders and refills that a given store's customers (i.e., consumers) have placed on the store's website.

### DETAILED DESCRIPTION OF EMBODIMENTS OF THE INVENTION

In the disclosure that follows, in the interest of clarity, not all features of actual implementations are described. It will of course be appreciated that in the development of any such actual implementation, as in any such project, numerous engineering and design decisions must be made to achieve the developers'specific goals and subgoals (e.g., compliance with system- and business-related constraints), which will vary from one implementation to another. Moreover, attention will necessarily be paid to proper engineering and design practices for the environment in question. It will be appreciated that such a development effort might be complex and time-consuming, but would nevertheless be a routine undertaking for those of skill in the art.

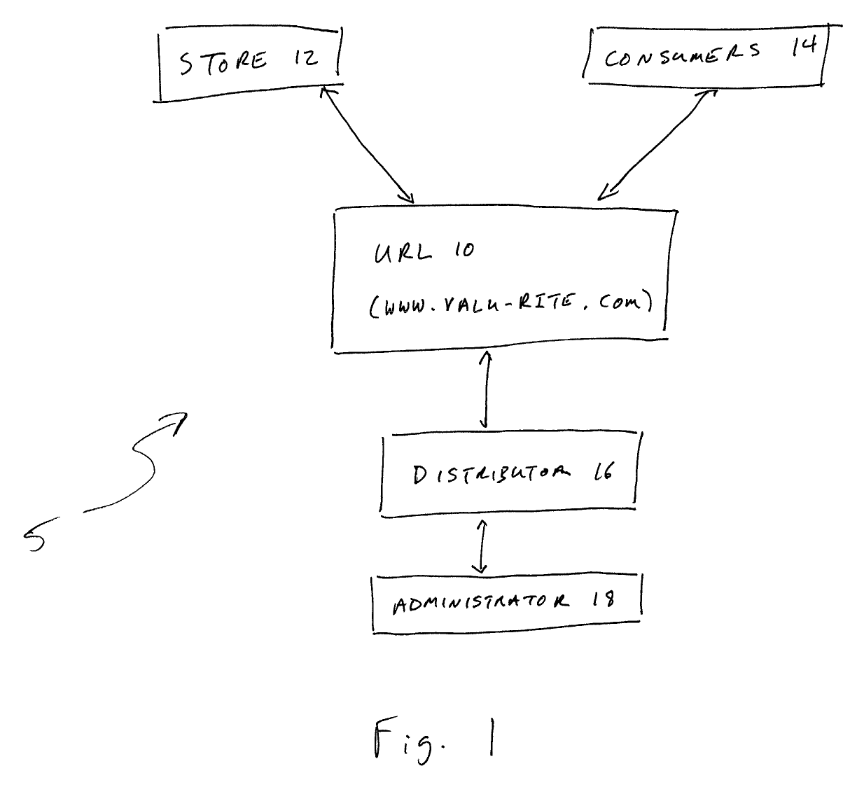

The basic internet-based system 5 is disclosed in FIG. 1. In the interest of simplicity, system 5 will be disclosed with reference to the distribution and purchase of pharmaceuticals through Valu-Rite® pharmacy stores, although one skilled in the art will realize that a commercially useful implementation is not so limited. The centerpiece of the system is the distributor's URL 10, which for example purposes is illustrated as “http://www.valu-rite.com.” A store selling Valu-Rite® products, a consumer desiring to buy Valu-Rite® or other products, and the distributor of Valu-Rite® products can access URL 10 from terminals 12, 14 and 16 respectively. In the case of the store terminal 12 and the consumer terminal 14, these terminals are usually a personal computer. Of course, in an actual commercial implementation, there would normally be many store and consumer terminals 12 and 14, but only one each is shown in FIG. 1 for simplicity.

The distributor terminal 16 will usually, but not necessarily, be a more complex system, and in fact may preferably comprise a number of sub-terminals useful for updating numerous pieces of information accessible though the URL 10. Thus, under the control of the distributor's administrator 18, distributor terminal 16 can be used to supply, amongst other things, product information, pharmacy data, retail price data, NABP (National Association of Boards of Pharmacy) data, product images, health information, and pharmacy locations (including on-line maps) to URL 10. As one skilled in the art will recognize, some of this information can be interactively supplied to URL 10 by other on-line systems. For example, the mapping information and health information can be supplied by an affiliation with MapQuest.com and YourHealth.com. Other such affiliations may greatly ease the burden placed on administrator 18 in updating and maintaining the system.

From consumer terminal 14, a given consumer accessing URL 10 can query the system to find a store or stores near to them, receive information concerning the location of those stores (including mapping information), and access those store's websites to perform on-line shopping. Either from URL 10 or from the store's websites, the consumer may also receive a list of available products and prices, and also receive related health or product information. When a consumer orders a product from the website of a given local store, the consumer also receives an e-mail notifying him or her that the order has been filled.

From store terminal 12, a given Valu-Rite® store accessing URL 10 can be notified that a consumer has ordered a certain product from its store and can send confirmation that the order has been filled (information which is then passed on to consumer terminal 14). Also, and importantly, a store can build its own customized website using the website “wizard” provided by URL 10, and can also order products from the distributor.

While more of the specifics of system 5 will be discussed later in more detail, it is useful at this point to appreciate the several benefits that the above system provides. First, the system, through the use of the website wizard, allows the stores supplied by the distributor to establish an on-line presence in a convenient and economical fashion. Furthermore, the relatively uniform creation of store websites in this fashion allows the distributor to pass on product and pricing information to stores' websites interactively, a feat which is not as easily realized if all of the distributor's stores were creating their own websites. Moreover, another convenient feature for the stores is the ability to purchase products from the distributor directly through the internet. Also, from the perspective of the consumer, purchasing of products on-line is transformed into a more personalized experience, where products can be purchased from their local Valu-Rite® pharmacist down the street, as opposed to impersonally buying products from some nameless, faceless source in cyberspace.

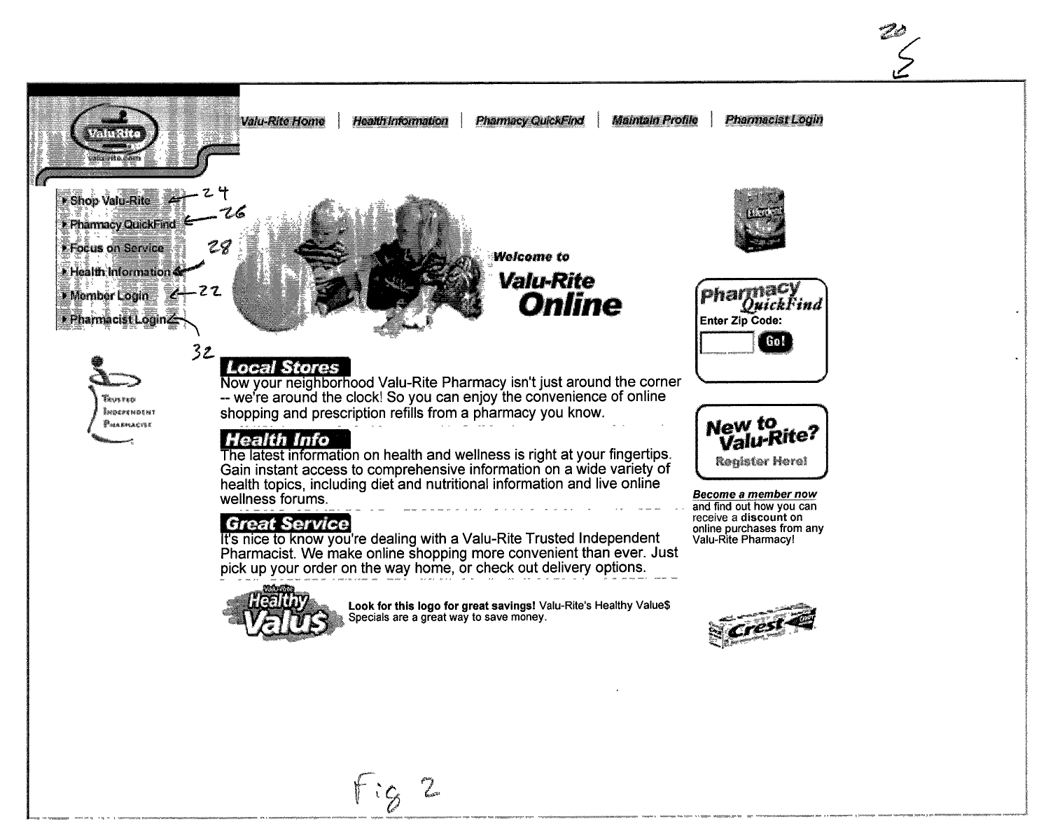

FIG. 2 shows a screen shot of the home page 20 for URL 10 (i.e., www.valu-rite.com). It should be noted that not all of the screen shots for this website are disclosed in the following figures because the implementation of many of the aspects of the site are either well known to those of ordinary skill in the art or are as easily explained in text. Home page 20 provides an implementation of many of the previously discussed functions. The consumer can register to become a Valu-Rite® member on-line by entering member login link 22 and answering certain basic questions, such as name, address, and phone number, and thereafter receiving a member identification code (i.e., ID) and password. Thereafter, the consumer can purchase products on-line by entering shopping link 24. If the consumer needs to first locate a pharmacy close to his or her home, the pharmacy QuickFind link 26 can assist the consumer. Under this link, the consumer enters basic geographic information such as his address, zip code, and phone number, and the system will then provide a list of pharmacies registered with URL 10 that are within a certain number of miles from the consumer. Maps showing the locations of local stores may also be provided. Health information is provided at health information link 28.

Stores (e.g., pharmacies) can also login in to the system at pharmacist login link 32. Upon entering the pharmacist login link 32, the pharmacist is prompted to enter its ID and password if he or she is a current member. If the pharmacist is new to the system, the system prompts the pharmacist to supply a distributor-provided ID (which is usually mailed to the store or supplied thereto by phone or e-mail) plus the pharmacist's NABP number before the system issues a system ID and password.

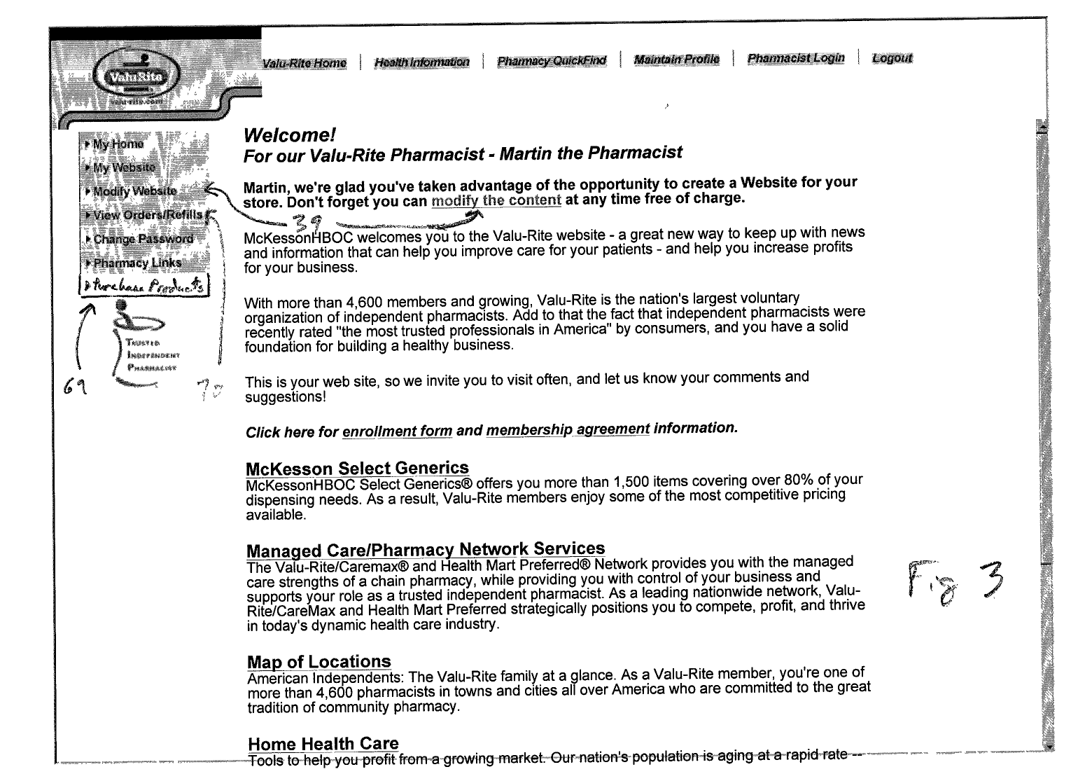

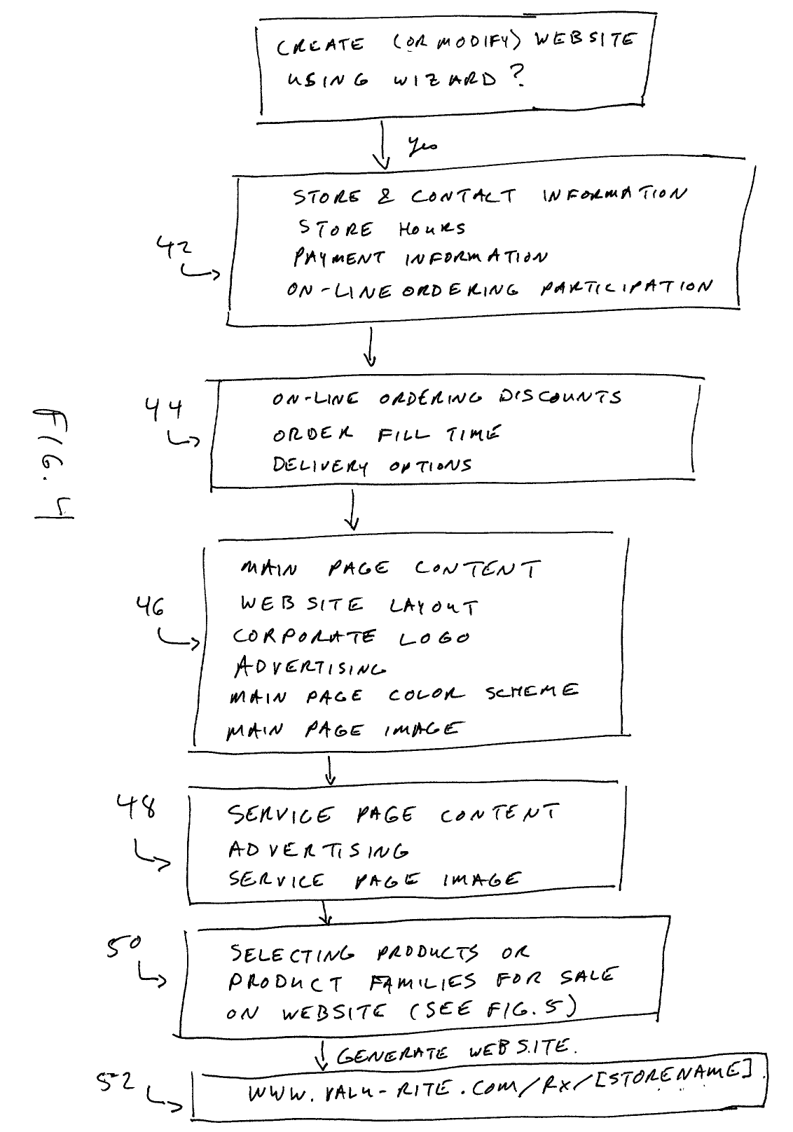

After a pharmacy is registered with the system, the system provides powerful functionality to the store, including the ability to generate its own website. This process is facilitated by the use of a website “wizard” which is stored on distributor terminal 16. When a newly registered pharmacist logs into the system, they are present with a screen, e.g., FIG. 3, in which he or she is invited to create a store website (or to modify a preexisting store website) at link 39. (FIG. 3 shows the “modification” screen because the pharmacist in this application has previously created his or her website). When link 39 is chosen, a series of screens (42, 44, 46, 48 and 50) are presented to the pharmacist which enable the customized generation of a store website. The content of these wizard screen is shown in flow-chart format in FIG. 4. (This approach of generating an otherwise complicated document or file by the mere input of certain content to appear in the document or file is commonly known as a “wizard”).

Referring to FIG. 4, at the first screen 42, the pharmacist is prompted to enter certain basic information such as “store & contact information,” “store hours,” “payment information” (i.e., what types of payment will the pharmacist accept for on-line sales), and “on-line ordering participation” (i.e., would the pharmacist like to ability to offer prescriptions and over-the-counter (OTC) products on-line).

At the second screen 44, the pharmacist is prompted to input information concerning “on-line ordering discounts” (e.g., a percentage savings for the on-line purchaser), “order fill time” (i.e., a target time for filling consumers'orders), “delivery options” (i.e., will the store deliver, mail, or simply allow for consumer pick up).

At the third screen 46, the pharmacist is prompted to input information concerning the “main page content” (e.g., two paragraphs of text that will appear on the main page of the store's website), “website layout” (which allows a choice of four layouts for the main website), “corporate logo” (which allows a corporate logo to be uploaded from the pharmacists' computer), “advertising” (which allows an advertisement to be uploaded from the pharmacists' computer to the main page), a “main page color scheme” option, and a “main page image” (which allows the pharmacist to choose one of several images or to upload an image of his or her own such as his or her storefront).

At the fourth screen 48, the pharmacist is prompted to input information concerning the “service page content” (e.g., two paragraphs of text that will appear on the service page of the store's website), “advertising” (which allows an advertisement to be uploaded from the pharmacists' computer to the service page), and a “service page image” (which allows the pharmacist to choose one of several images or to upload an image of his or her own).

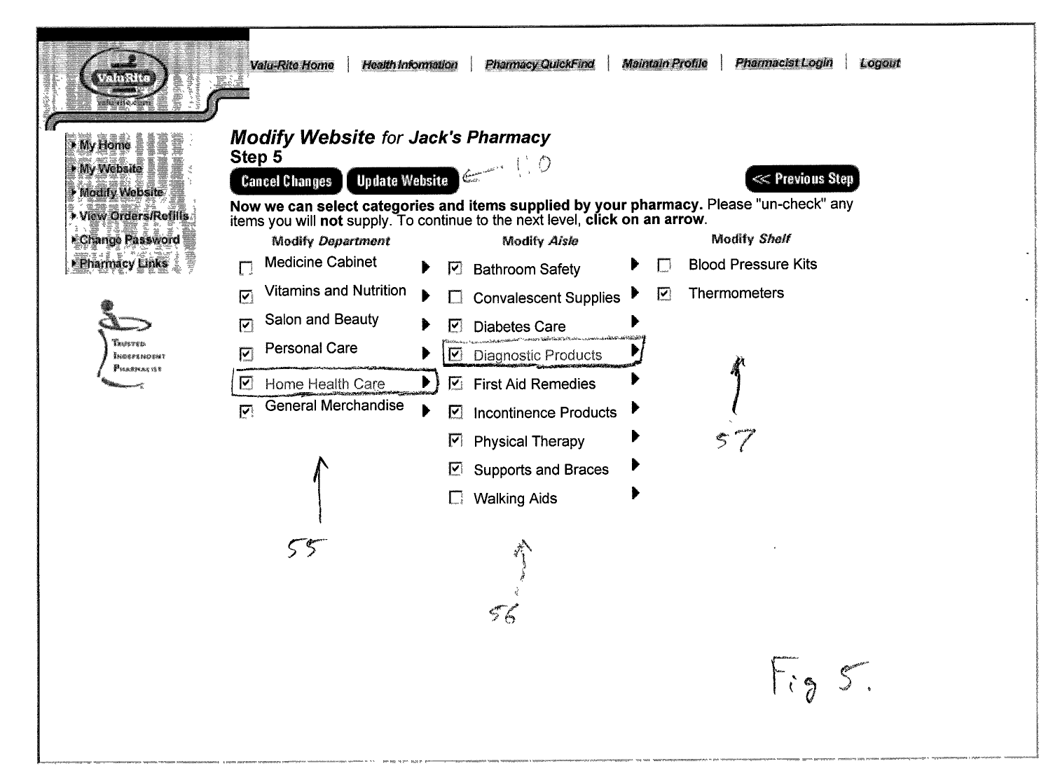

The fifth screen 50 of the wizard is shown in FIG. 5. At this portion of the wizard, the pharmacist can choose those types of the distributor's products or product families that will automatically appear for sale on the store website to be created. To simplify the choosing of product families, the products are broken down into a hierarchical “department” 55, “aisle” 56, and “shelf” 57 format. In this example, the pharmacist has already decided not to offer for sale any products occurring in the “medicine cabinet” department, and accordingly has deselected the box next to this label. Currently, the pharmacist is viewing the “home health care” department, and more specifically those product families appearing in the “diagnostic products” aisle. In this aisle, “blood pressure kits” and “thermometers” appear on the shelf. The pharmacist has chosen not to offer “blood pressure kit” for sale, and also has chosen not to sell anything in the “convalescent supplies” aisle, most likely for the reason that the pharmacist does not purchase these products from the distributor and therefore does not have such products on hand. However, there may be other reasons for the pharmacist not to choose to sell certain products on-line, such as because those products are simply to costly or difficult to deliver to the consumer. One of ordinary skill will realize that more detail can be built into the product hierarchy shown. For example, a fourth level called “brand” could appear as another level of detail under shelf 57, which could list certain brand names and even the specific products to be offered. As previously noted, the ability of the store to pick those items for sale on its website is important because it allows for interaction between the store and distributor's website (to be explained shortly) but not as to those products that the store does not want to sell.

After the screens of the wizard have been filled in, and after clicking the “Update Website” button 110, the pharmacist's website is ready for viewing. The default on-line store path 52 generated by the system for the new website will be http://www.valu-rite.com/Rx/storename, where “storename” is an alpha string formed of the entered store name with all special characters (such as blanks or dashes) discarded. In a preferred embodiment, the store's path 52 only exists underneath the distributor URL 10, and accordingly the store is not issued (and nor does the system preferably attempt to register) a URL for the store, although the system could be easily modified to accomplish this function. (Of course, one skilled in the art will realize that a store could, independently of the system, seek to register its own URL, and link this URL to the path 52).

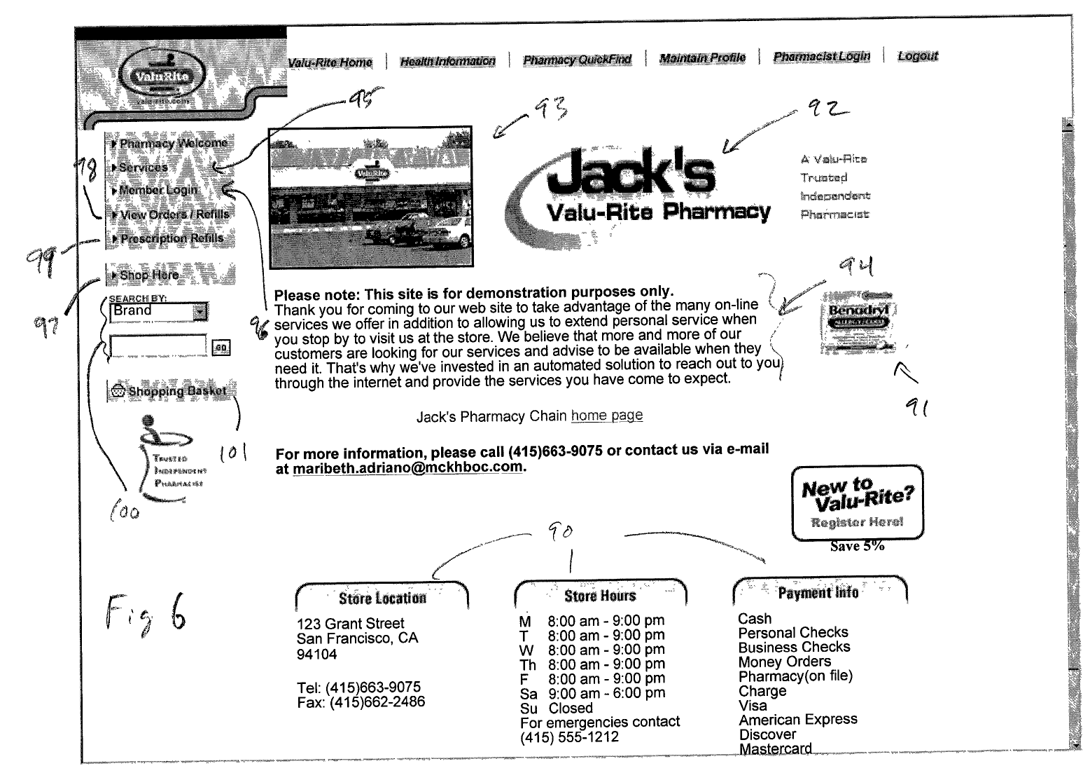

An example of the main page of a store website generated by the wizard is shown in FIG. 6 for Jack's Valu-Rite® Pharmacy, which is accessible by the consumer at http://valu-rite.com/Rx/jacksvaluritepharmacy. The layout of Jack's website is dictated by the layout that Jack chose during his interaction with the website wizard, as described above. Also present on the main page are Jack's store location, hours, and payment information 90, a main page advertisement 91, Jack's corporate logo 92, an image of Jack's storefront 93, Jack's main page text 94, and a link 95 to enter Jack's service page. As in a traditional website, the consumer, after logging in at link 96 (which is redundant of link 22 of FIG. 2), can shop 97, order prescription refills 99, and view their orders and refills 98. A website search engine 100, and a “shopping basket” 101 which provides a summary of the consumer's order, add extra speed and ease to the consumer's on-line shopping experience. Of course, all such websites created by the disclosed wizard will have essentially the same frame look and feel, but making a more complex wizard program with more flexibility could easily change this.

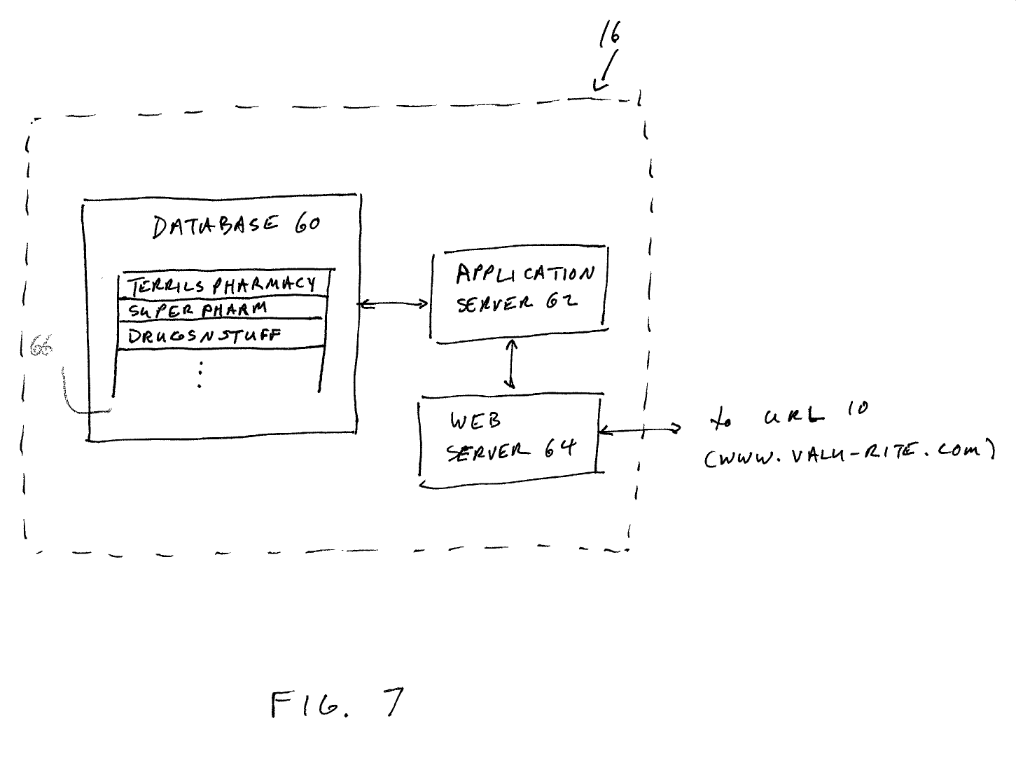

The distributor terminal 16 used to implement the disclosed system is shown in further detail in FIG. 7, which shows a database 60, an application server 62, and a web server 64. The raw data for the web pages for each of the registered stores is stored in various files 66 residing in database 60. When a consumer attempts to pull up the website (e.g., www.valu-rite.com/Rx/superphram) for a particular store, the raw data from the corresponding file 66 (e.g., superpharm) is passed to the application server 62. This raw data corresponds to the data that the pharmacist entered into the wizard: store name, store hours, etc. The application server essentially converts the raw data in a given file 66 into an “html” format that the consumer can view on his monitor screen. As is well known to those of skill in the art of internet programming, this conversion process can be facilitated by the use of several commercial products such as “WebLogic”™, which contains the java programming language necessary to effect the conversion. It is at this step of the process that the actual layout of the website takes shape. Using the java program, the raw store data is converted into a graphical html image that corresponds to the layout that the pharmacist chose in the wizard. Once the data is transferred into html, it can then be served up to the consumer on the web by web server 64. This approach allows the store's websites to be dynamically and instantaneously updated, instead of maintaining the stores'websites as static html images on the database 60. This is beneficial, given that a store may quickly and easily modify its website as described above, for example, to change the frame look and feel of its websites in the future.

One of skill in the art will appreciate that an actual implementation of the hardware disclosed in FIG. 7 would preferably contain other components, such as “firewalls” to maintain system security and redundant components to ensure system integrity in the event of system failure. However, because such elements are well known and well understood to the designers of internet systems, they are not disclosed herein. Furthermore, while many commercially-available hardware and software packages may be used when designing the system described here, the following components are presently preferred: for the database 60, an Oracle™ database running Oracle version 8.0.5; for the application server 62, a BEA WebLogic application server running WebLogic version 4.5.1 and JDK 1.1.7-08; and for the web server 64, a Netscape Enterprise server running version 3.6.2d and WebLogic NSAPI bridge version 4.5.1 SP7 (which comes with WebLogic).

Once registered, and once a website for a given store has been generated, the ability of that store to electronically communicate with the distributor is greatly increased, with several beneficial results. First, because stores' website are stored on the distributor's database 60 and because the data format of the websites is necessarily known to the distributor by virtue of the wizard that the distributor provides, data appearing on stores' websites are easily updated by the distributor. Examples of such information that may be usefully updated includes pricing data, health information, manufacturer's updates and warnings, etc.

Moreover, not only can the store decide what products it wishes to sell over the internet by selecting certain products or product groups during the wizard, the store can also use its electronic connection with the distributor to actually purchase products from the distributor. This option may be presented to the pharmacist upon login to the system (FIG. 3) as purchase products link 69. Upon entering this link, the pharmacist is presented with a list of the distributor's products for purchase, their purchase price, part numbers, etc. From this list, the pharmacist enters information concerning the number of units he or she would like to buy, credit information, and other information needed to close the transaction with the distributor. Moreover, the system could be set up in such a way that the distributor knows the quantity of a particular product on a particular store's shelves, and automatically sells a replenishing number to the store without the need of any interaction by the pharmacist. Such on-line methods of purchasing products in this fashion are well known and need not be further described here.

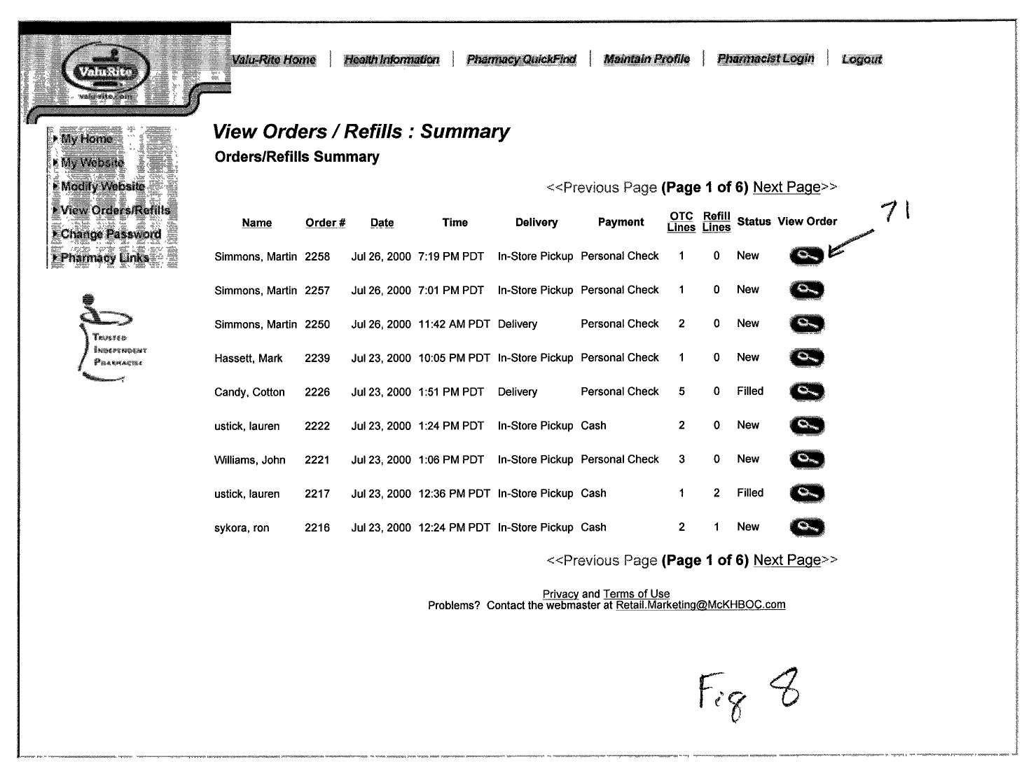

Another advantage provided by the system is the ability for the stores to login and review on-line orders that have been placed by that store's customers. Referring again to FIG. 3, the pharmacist reviews placed orders by clicking on the “view orders/refills” link 70. From this screen, all active orders (orders for which delivery has not yet been made), are viewed in summary fashion as shown in FIG. 8. This summary shows the consumer's name, order number, the date and time the order was placed, delivery and payment methods, the number of OTC products or prescription refills ordered, and the order's status as new or filled. A view order link 71 is also included which allows the specific details of a specific order to be reviewed by the pharmacist (not shown), including the exact product or refill purchases, their prices, and consumer contact information and consumer comments. An order status reminder is provided which notifies the store that a particular order is overdue (in accordance with the “order fill time” entered earlier upon creation of the website), although this is not shown. Furthermore, one of ordinary skill will realize that the system could be easily modified to automatically present updates such as that shown in FIG. 7 to the pharmacists on a periodic basis, for example, by fax or e-mail. However, this modification is presently not preferred because it is believed prudent to have the pharmacist proceed through the log in procedure to procure such data, as opposed to having it automatically routed out of the system in an unsecured fashion.

Modifications and improvements upon the disclosed embodiments should be readily apparent to those of skill in the art having the benefit of this disclosure. For example, different hardware and software from those disclosed herein may be used to achieve the same advantages of the disclosed system. Moreover, many other beneficial features and functions could be added to the disclosed system to improve its value to the distributor, store, and consumer. Also, a distributor/store relationship is not necessary to achieve the advantages of the system disclosed herein, and one of skill will realize that many other types of relationships, including other franchising relationships, will be benefited by the use of the disclosed system. Finally, although the disclosed system has particular utility in the pharmacy context, the disclosed system is expected to have utility in numerous different contexts involving the distribution of other products and services. (As used herein, “product” should be understood as referring to both products and services).

From the foregoing detailed description of specific embodiments of the invention, it should be apparent that a highly integrated on-line product distribution system has been disclosed. Although specific embodiments of the invention have been disclosed herein in some detail, this has been done solely for the purposes of illustrating various aspects and features of the invention, and is not intended to be limiting with respect to the scope of the invention. It is contemplated that various substitutions, alterations, and/or modifications, including but not limited to those design alternatives which might have been specifically noted in this disclosure, may be made to the disclosed embodiment without departing from the spirit and scope of the invention as defined in the appended claims.

What is claimed is:

1. A system for creating and updating a store website, comprising a first terminal coupled to a URL, the first terminal containing a program thereon to enable at least one store to create a store website offering products for sale by accessing the URL, wherein the first terminal periodically updates the store website with information related to the offered products.

2. The system of claim 1, wherein the first terminal includes a database, an application server coupled to the database, and a web server coupled to both the application server and to the URL.

3. The system of claim 1, wherein the store website is stored in the first terminal.

4. The system of claim 1, wherein the first terminal includes a database, an application server coupled to the database, and a web server coupled to both the application server and to the URL, and wherein the store website is stored in the database.

5. The system of claim 1, wherein the store website is accessible through the URL.

6. The system of claim 1, wherein the program is a wizard.

7. The system of claim 6, wherein the wizard prompts the store to input data, the data selected from the group consisting of the store name, store contact information, store hours, store payment options, store on-line ordering participation, store on-line ordering discounts, store order fill time, store delivery options, store website text, store website layout, store corporate logo, advertisements, store website color scheme, images, and products to be sold on the store website.

8. The system of claim 1, wherein the store website includes features selected from the group consisting of a product search engine, a shopping basket, a shopping link, a view orders link, store hours, a corporate logo, and an advertisement.

9. The system of claim 1, wherein the store website appears as a path under the URL.

10. The system of claim 1, wherein the information includes pricing information for the offered product.

11. The system of claim 1, wherein the first terminal is a distributor's terminal, and wherein the distributor distributes products to the store.

12. The system of claim 1, wherein the URL includes a store login link to allow the store to access the system.

13. The system of claim 12, wherein the access is only allowed after inputting of both a store ID and a store password from the store's terminal.

14. The system of claim 1, further comprising at least one store's terminal coupled to the URL, the store's terminal usable by the store at least to engage the program to create the store website.

15. A method for creating and updating at least one store website, the method implementable on a system including a first terminal coupled to the a URL, the method comprising:
operating a program on the first terminal to enable a store to create a store website offering products for sale by accessing the URL; and
periodically updating the store website with information related to the offered products.

16. The method of claim 15, wherein the first terminal includes a database, an application server coupled to the database, and a web server coupled to both the application server and to the URL.

17. The method of claim 15, further comprising storing the store website in the first terminal.

18. The method of claim 15, wherein the first terminal includes a database, an application server coupled to the database, and a web server coupled to both the application server and to the URL, and further comprising storing the store website in the database.

19. The method of claim 15, wherein the store website is accessible as a path under the URL.

20. The method of claim 2, wherein the program is a wizard.

21. The method of claim 20, wherein the wizard prompts the store to input data, the data selected from the group consisting of the store name, store contact information, store hours, store payment options, store on-line ordering participation, store on-line ordering discounts, store order fill time, store delivery options, store website text, store website layout, store corporate logo, advertisements, store website color scheme, images, and products to be sold on the store website.

22. The method of claim 15, wherein the store website includes features selected from the group consisting of a product search engine, a shopping basket, a shopping link, a view orders link, store hours, a corporate logo, and an advertisement.

23. The method of claim 15, wherein the store website appears as a path under the URL.

24. The method of claim 15, wherein the information includes pricing information for the offered products.

25. The system of claim 15, wherein the first terminal is a distributor's terminal, and wherein the distributor distributes products to the store.

26. The method of claim 15, further comprising accessing the URL from a store's terminal to create the store website by engaging the program residing upon the first terminal.

27. The method of claim 26, wherein accessing the URL from the store's terminal includes accessing a store login link.

28. The method of claim 27, wherein accessing the store login link includes inputting of both a store ID and a store password from the store's terminal.

29. A system for distributing products over the internet, the system usable by a distributor that distributes products to at least one store, the system comprising a distributor's terminal coupled to a URL, wherein the distributor's terminal contains a program thereon to enable at least one store to create a store website for offering products to consumers by accessing the URL.

30. The system of claim 29, wherein the distributor's terminal includes a database, an application server coupled to the database, and a web server coupled to both the application server and to the URL.

31. The system of claim 29, wherein the store website is stored in the distributor's terminal.

32. The system of claim 29, wherein the distributor's terminal includes a database, an application server coupled to the database, and a web server coupled to both the application server and to the URL, and wherein the store website is stored in the database.

33. The system of claim 29, wherein the store website is accessible through the URL.

34. The system of claim 29, wherein the program is a wizard.

35. The system of claim 34, wherein the wizard prompts the store to input data, the data selected from the group consisting of the store name, store contact information, store hours, store payment options, store on-line ordering participation, store on-line ordering discounts, store order fill time, store delivery options, store website text, store website layout, store corporate logo, advertisements, store website color scheme, images, and products to be sold on the store website.

36. The system of claim 29, wherein the store website includes features selected from the group consisting of a product search engine, a shopping basket, a shopping link, a view orders link, store hours, a corporate logo, and an advertisement.

37. The system of claim 29, wherein the store website appears as a path under the URL.

38. The system of claim 29, wherein the distributor's terminal periodically updates the store website with information related to the offered products.

39. The system of claim 38, wherein the information includes pricing information for the offered products.

40. The system of claim 29, wherein the URL includes a store login link to allow the store to access the system.

41. The system of claim 40, wherein the access is only allowed after inputting of both a store ID and a store password.

42. The system of claim 29, wherein the URL includes a consumer login link to allow a consumer to access the system.

43. The system of claim 42, wherein the access is only allowed after inputting of both a consumer ID and a consumer password.

44. The system of claim 29, further comprising at least one store's terminal coupled to the URL, the store's terminal usable by the store at least to engage the program to create the store website.

45. The system of claim 29, wherein a consumer can search for a store in his locale from the URL.

46. The system of claim 29, wherein products ordered from the store website are viewable by the store upon accessing the URL.

47. The system of claim 29, wherein the distributor's terminal also contains a second program thereon to enable the store to order products from the distributor by accessing the URL.

48. A method for distributing products over the internet, the method usable by a distributor that distributes products to at least one store, the method implementable on a system including a distributor's terminal coupled to a URL, the method comprising operating a program on the distributor's terminal to enable a store to create a store website offering the distributor's products for sale by accessing the URL.

49. The method of claim 48, wherein the distributor's terminal includes a database, an application server coupled to the database, and a web server coupled to both the application server and to the URL.

50. The method of claim 48, further comprising storing the store website on the distributor's terminal.

51. The method of claim 48, wherein the distributor's terminal includes a database, an application server coupled to the database, and a web server coupled to both the application server and to the URL, and further comprising storing the store website in the database.

52. The method of claim 48, wherein the store website is accessible as a path under the URL.

53. The method of claim 48, wherein the program is a wizard.

54. The method of claim 53, wherein the wizard prompts the store to input data, the data selected from the group consisting of the store name, store contact information, store hours, store payment options, store on-line ordering participation, store on-line ordering discounts, store order fill time, store delivery options, store website text, store website layout, store corporate logo, advertisements, store website color scheme, images, and products to be sold on the store website.

55. The method of claim 48, wherein the store website includes features selected from the group consisting of a product search engine, a shopping basket, a shopping link, a view orders link, store hours, a corporate logo, and an advertisement.

56. The method of claim 48, wherein the store website appears as a path under the URL.

57. The method of claim 48, further comprising periodically updating the store website with information from the distributor's terminal.

58. The method of claim 57, wherein the information includes pricing information for the offered products.

59. The method of claim 48, further comprising accessing the URL from a store's terminal to create the store website by engaging the program residing upon the first terminal.

60. The method of claim 59, wherein accessing the URL from the store's terminal includes accessing a store login link.

61. The method of claim 60, wherein accessing the store login link includes inputting of both a store ID and a store password from the store's terminal.

62. The method of claim 48, further comprising accessing the URL from a consumer's terminal coupled to the URL to purchase the products offered for sale on the store website.

63. The method of claim 62, wherein accessing the URL from the consumer's terminal includes accessing a consumer login link.

64. The method of claim 63, wherein accessing the consumer login link includes inputting of both a consumer ID and a consumer password from the consumer's terminal.

65. The method of claim 48, further comprising accessing the URL from a consumer's terminal to search for a store in the consumer's locale.

66. The method of claim 48, further comprising operating a second program on the distributor's terminal to enable the store to order products from the distributor.

67. A method for creating at least one store website, the method implementable on a system including a store's terminal coupled to a URL, a first terminal coupled to a URL, and a program residing on the first terminal which allows the store to create a website offering products for sale, the method comprising:
accessing the URL from the store's terminal to engage the program; and
inputting into the program which products the store will sell on the store website.

68. The method of claim 67, wherein the first terminal includes a database, an application server coupled to the database, and a web server coupled to both the application server and to the URL.

69. The method of claim 67, further comprising storing the store website in the first terminal.

70. The method of claim 67, wherein the first terminal includes a database, an application server coupled to the database, and a web server coupled to both the application server and to the URL, and further comprising storing the store website in the database.

71. The method of claim 67, wherein the store website is accessible as a path under the URL.

72. The method of claim 67, wherein the program is a wizard.

73. The method of claim 72, wherein the wizard prompts the store to input data, the data selected from the group consisting of the store name, store contact information, store hours, store payment options, store on-line ordering participation, store on-line ordering discounts, store order fill time, store delivery options, store website text, store website layout, store corporate logo, advertisements, store website color scheme, images, and products to be sold on the store website.

74. The method of claim 67, wherein the store website includes features selected from the group consisting of a product search engine, a shopping basket, a shopping link, a view orders link, store hours, a corporate logo, and an advertisement.

75. The method of claim 67, wherein the store website appears as a path under the URL.

76. The method of claim 67, further comprising periodically updating the store website with information related to the offered products.

77. The method of claim 76, wherein the information includes pricing information for the offered products.

78. The system of claim 67, wherein the first terminal is a distributor's terminal, and wherein the distributor distributes products to the store.

79. The method of claim 67, wherein accessing the URL from the store's terminal includes accessing a store login link.

80. The method of claim 79, wherein accessing the store login link includes inputting of both a store ID and a store password from the store's terminal.
